(19) United States
(12) Patent Application Publication
(10) Pub. No.: US 2017/0221655 A1
(43) Pub. Date: Aug. 3, 2017

(54) KEYBOARD DEVICE

(71) Applicant: WEI-MING WANG, TAIPEI (TW)

(72) Inventor: WEI-MING WANG, TAIPEI (TW)

(21) Appl. No.: 15/008,750

(22) Filed: Jan. 28, 2016

(51) Int. Cl. H01H 13/84

(52) U.S. Cl. CPC H01H 13/84; H01H 13/7065

(57) ABSTRACT

A keyboard device with an upper housing and an under housing is disclosed, which includes a stopping piece integrally formed on the upper housing and having an upper surface and a lower surface, a key top having a side portion and an operating piece having an operating portion, and a first silencing pad disposed between the operating portion and the lower surface.

### FIELD OF THE INVENTION

The present invention relates to a silent keyboard device, specifically to a keyboard device where a silicon pad is configured to eliminate sounds caused by pressing down the keys of the keyboard device.

### BACKGROUND OF THE INVENTION

The common keyboard used for a computer always makes sounds when the keys are tapped, but these sounds often bother users who need quiet. In addition, some people still use their keyboards in the office during lunchtime, and these sounds could disturb other people who are trying to take a break. Please refer to FIG. 1, which is a cross-sectional view of a conventional keyboard structure. A keyboard 10 includes an upper housing and a under housing, the upper housing includes a key top 11, a crater-like depression 12, a column 13, two tenons 14 moving within the crater-like depression 12 in a balanced manner, left and right side portions 15, left and right top portions 16 (i.e., a stopping piece, which has a regular height/thickness (DP, not shown) of 1.4 mm) and two outer portions 19, wherein the outer portions 19 embed below a keyboard surface of the keyboard 10 with an embedded depth (ED) of 2 mm The under housing includes a conductive membrane 17 and a silicone hemisphere (silicone rubber dome) 18. The silicone rubber dome 18 prevents the column 13 from hitting the conductive membrane 17 when the key top 11 is pressed down.

The reason why the existing keyboard makes noise can be understood from FIG. 2. That is to say, it is usually nothing else but the sounds caused by the side portions 26 hitting an upper surface 231 of the top portion 23 when the key is pressed down (of course, if the column 25 pushes the silicone rubber dome 28 to hit the conductive membrane 27, a clicking sound caused by hitting the conductive membrane 27 also occurs), and the sound caused by an operating portion 241 of the tenons 24 hitting a lower surface 232 of the top portion 23 after the column 25 of the key top 21 is rebound by the hemisphere 28 (where the lower surface 232 is used to prevent the tenons 24 from disengaging and falling off). That is to say, when pressing down the keys of the keyboard, the sounds are made by the key top 21 hitting the conductive membrane 27 (hereinafter abbreviated as ‘site A’), the upper surface 231 (hereinafter abbreviated as ‘site B’) and the lower surface 232 (hereinafter abbreviated as ‘site C’).

Therefore, there need to eliminate the problem of clicking sounds made at sites A, B and C when pressing down the keys of the keyboard. The inventor of the present application endeavored in experiments, tests and research, and has finally obtained a keyboard device, where clicking sounds made at sites A, B and C not only disappear effectively when pressing down the keys of the keyboard, but also make typing more fluent. In other words, the problems to be solved by the present invention are that, when pressing down the keys of the keyboard, how to overcome the problem of clicking sounds made at site C (so as to make the key top rebound soundlessly), site A and site B. The summary of the present invention is described below.

### SUMMARY OF THE INVENTION

The major purpose of the present invention is to effectively eliminate the clicking sounds made at sites A, B and C when pressing down the keys of a novel keyboard device, wherein silencing pads are used to prevent the key top from hitting sites A, B and C.

In the present invention, a keyboard device having an upper housing and a under housing is provided. The keyboard device includes a stopping piece integrally formed on the upper housing and having an upper surface and a lower surface, a key top having a side portion and an operating piece having an operating portion, a first silencing pad disposed between the operating portion and the lower surface and a second silencing pad disposed between the side portion and the upper surface.

The keyboard device of present invention is a conventional keyboard or a thin keyboard, wherein the stopping piece is a top portion of a crater-like depression.

The keyboard device of present invention further includes an elastic body (i.e. a silicone rubber dome) disposed on the under housing. The key top further comprises a column, and the column pushes the elastic body when the key top is pressed down. According to the present invention, each of the first silencing pad and the second silencing pad is one of a silicone pad and a thermoplastic polyurethane (TPU) pad having a thickness of 1 mm.

The present invention also discloses a keyboard device having an upper housing and a under housing is provided. The keyboard device includes a stopping piece integrally formed on the upper housing and having an upper surface and a lower surface, a key top having a side portion and an operating piece having an operating portion and a first silencing pad disposed between the operating portion and the lower surface.

In the present invention, a method for manufacturing a keyboard is also disclosed, wherein the keyboard has the structure as described above. The method includes the step of forming the upper housing and the first silencing pad by an insert molding.

In the present invention, an alternative method for manufacturing a keyboard is disclosed, and the keyboard has the same structure as described above. The method includes a step of forming the upper housing and the first silencing pad by a double injection molding.

Other objective, advantages and efficacies of the present invention will be described in detail below taken from the preferred embodiments with reference to the accompanying drawings.

### BRIEF DESCRIPTION OF THE DRAWINGS

FIG. 1 is a cross-sectional view of a conventional keyboard structure.

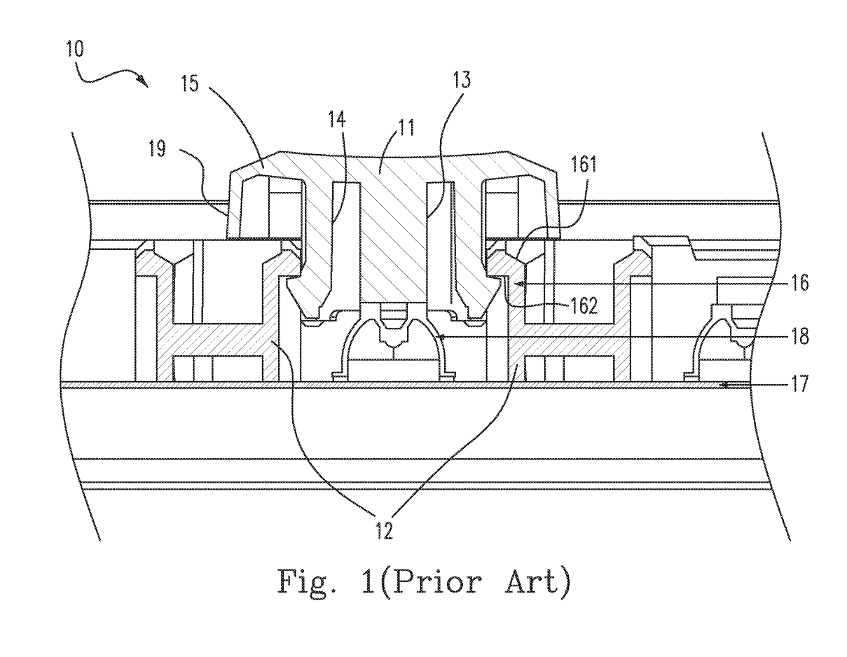

FIG. 2 is an enlarged diagram showing the sites B and C where the clicking sounds are occurred.

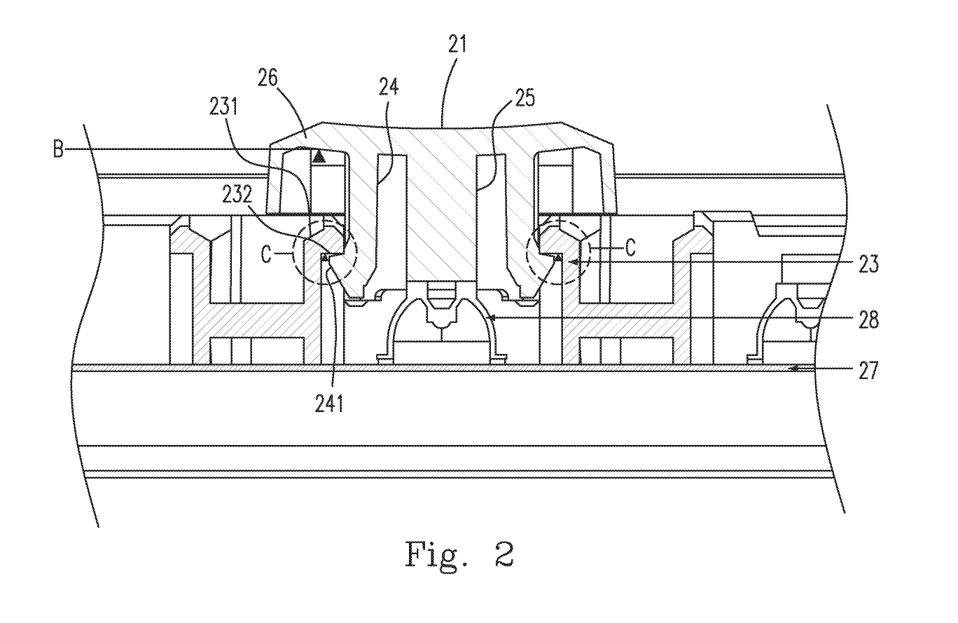

FIG. 3 is a cross-sectional view of the keyboard device according to a first embodiment of the present invention.

FIG. 4 is a cross-sectional view of the keyboard device according to a second embodiment of the present invention.

FIG. 5 is a cross-sectional view of the keyboard device according to a third embodiment of the present invention.

FIG. 6 is a cross-sectional view of the keyboard device according to a fourth embodiment of the present invention.

### DETAILED DESCRIPTION OF THE PREFERRED EMBODIMENTS

The present invention will now be described more specifically with reference to the following Embodiments. It is to be noted that the following descriptions of preferred Embodiments of this invention are presented herein for purpose of illustration and description only; they are not intended to be exhaustive or to be limited to the precise form disclosed. In the preferred embodiments, the same reference numeral represents the same element in each embodiment.

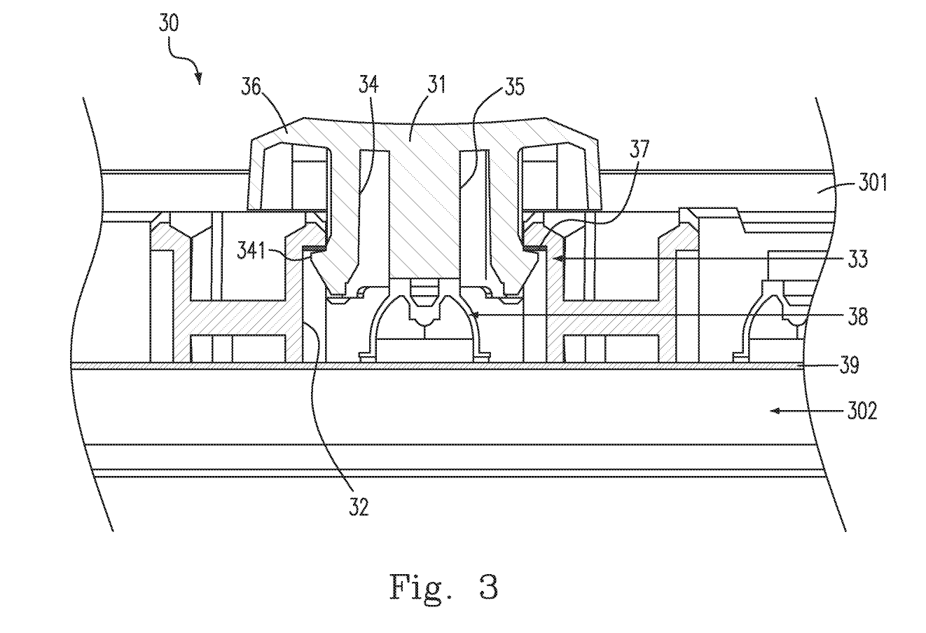

Because the clicking sound made at site A when the key top is pressed down is reduced significantly by the configuration of the silicone rubber dome, the main problem to be solved is the clicking sound made at site C when the key top rebounds. To eliminate the clicking sound made at site C when the key top rebounds, a silencing pad is disposed at site C. Please refer to FIG. 3, which is a cross-sectional view of the keyboard device 30 according to a first embodiment of the present invention. In the first embodiment of the present invention, the silencing pad is disposed at site C. The keyboard device 30 has a basic structure similar to that in a conventional keyboard and includes an upper housing 301 and an under housing 302. A key top 31 and a crater-like depression 32 are formed on the upper housing 301, and a silicone rubber dome 38 and a conductive membrane 39 are disposed on the under housing 302. The top portion of the crater-like depression 32 is a stopping piece 33 having an upper surface and a lower surface, and the key top 31 includes a side portion 36, two operating pieces 34 and a column 35. Each operating piece 34 includes an operating portion 341 engaging with the stopping piece 33 of the crater-like depression 32. The column 35 pushes the silicon rubber dome 38 when the key top 31 is pressed down, and thereby the sound made at site A is eliminated. The conductive membrane 39 has a three-layer structure including a first conductive layer, a protection layer and a second conductive layer, and the column 35 pushes the silicone rubber dome 38 to hit the conductive membrane 39, which electrically connects the first conductive layer with the second conductive layer. A silencing pad 37 is disposed between the operating portion 341 and the lower surface of the stopping piece 33 to prevent the key top 31 from contacting the stopping piece 33 when the key top 31 rebounds, and thereby the sound made at site C is eliminated. The first silencing pad 37 is a silicone pad or a thermoplastic polyurethane (TPU) pad.

This keyboard device 30 is a thin keyboard, in which each key is shorter in height in the cross-sectional view of the keyboard. Of course, the keyboard device 30 also can be replaced with a traditional keyboard where there are bigger silicone rubber domes configured and each key is taller in the cross-sectional view of the keyboard.

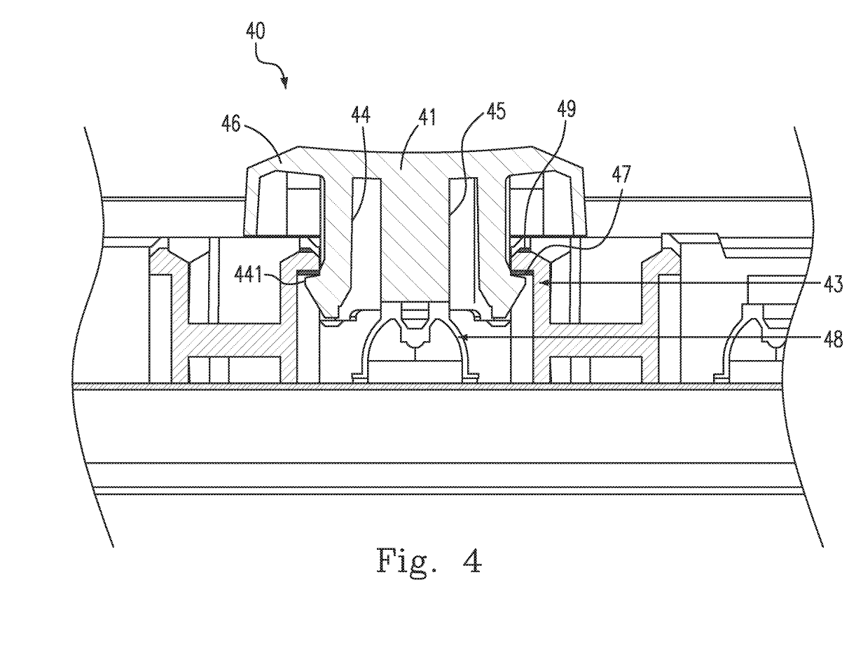

Please refer to FIG. 4, which is a cross-sectional view of the keyboard device 40 according to a second embodiment of the present invention. In the second embodiment of the present invention, the silencing pads are disposed at sites B and C. The keyboard device 40 has a basic structure similar to that in FIG. 3 except for the silencing pads. A first silencing pad 47 is disposed between the operating portion 441 and the lower surface of the stopping piece 43 to prevent the key top 41 from contacting the stopping piece 43 when the key top 41 rebounds, and thereby the sound made at site C is eliminated. To further eliminate the clicking sound when the key top 41 is pressed down, a second silencing pad 49 is disposed between the side portion 46 and the upper surface of the stopping piece 43 to eliminate the sound made at site B when the key top 41 is pressed down, even though the clicking sound made at site A when the key top 41 is pressed down is reduced significantly by the silicone rubber dome 48.

Each of the first silencing pad 47 and the second silencing pad 49 is a silicone pad or a thermoplastic polyurethane (TPU) pad having a thickness of 1 mm. When the key top 41 is pressed down, the side portion 46 moves down to touch the upper surface of the stopping piece 43, which decrease the extent that the silicone rubber dome 48 depressed by the column 45. When the key top 31 rebounds, the operating portion 441 touches the first silencing pad 47 to prevent the key top 41 from contacting the stopping piece 43.

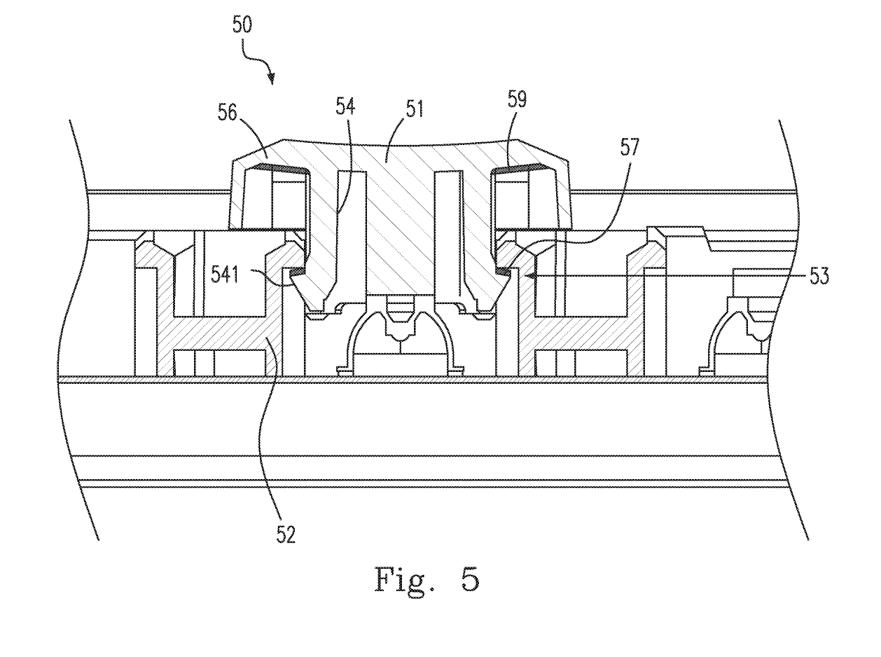

In the third embodiment, to eliminate the clicking sounds made at sites B and C, the first silencing pad and the second silencing pad may be disposed at positions different from that in the second embodiment. Specifically, the first silencing pad 47 and the second silencing pad 49 in FIG. 4 are disposed on the lower surface and the upper surface of the stopping piece 43, respectively. Alternatively, the first silencing pad 57 and the second silencing pad 59 in FIG. 5 are disposed on the operating portion 541 and the side portion 56 of the key top 51, respectively, as described in the following embodiment.

Please refer to FIG. 5, which is a cross-sectional view of the keyboard device 50 according to a third embodiment of the present invention. In the third embodiment of the present invention, the silencing pads are disposed at sites B and C. The keyboard device 50 has a basic structure similar to that in FIG. 4 except for the silencing pads. In this case, the silencing pads are designed on the key top 51 rather than on the stopping piece 53. A first silencing pad 57 is disposed on the operating portion 541 engaging with the lower surface of the stopping piece 53 to prevent the key top 51 from contacting the stopping piece 53 when the key top 51 rebounds, and thereby the sound made at site C is eliminated. A second silencing pad 59 is disposed on the bottom surface of the side portion 56 that contacts the upper surface of the stopping piece 53 to eliminate the sound made at site B when the key top 51 is pressed down. Comparing to the keyboard device 40 in the second embodiment, this design has advantages of manufacturing the key top in a large amount in the same mold and saving the cost.

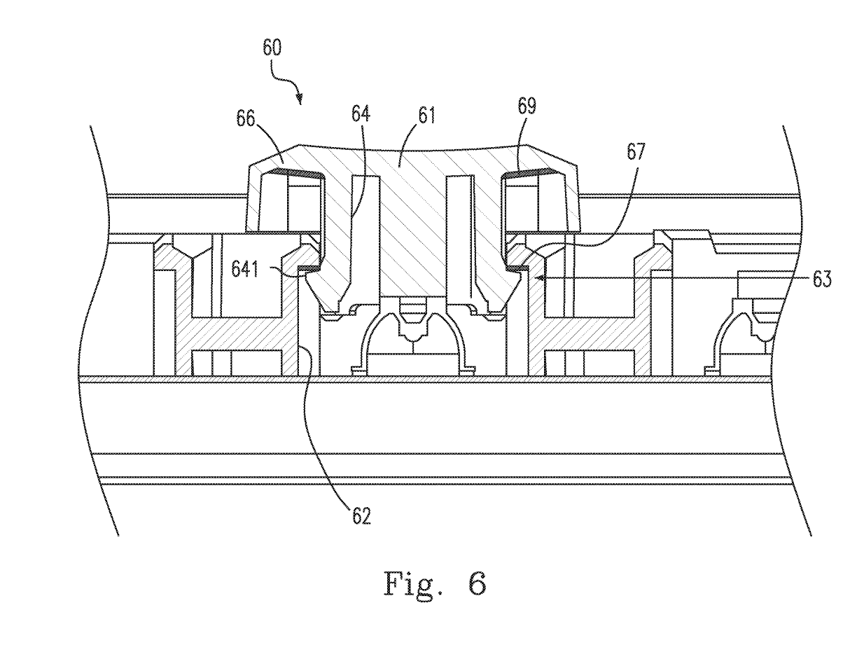

Please refer to FIG. 6, which is a cross-sectional view of the keyboard device 60 according to a fourth embodiment of the present invention. In the third embodiment of the present invention, the silencing pads are disposed at sites B and C. The keyboard device 60 has a basic structure similar to that in FIG. 4 except for the silencing pads. In the previous embodiments, both of the silencing pads are disposed on either the stopping piece or the key top. In this case, without considering the cost, one silencing pad is designed on the key top 61 and other silencing pad is disposed on the stopping piece 63. A first silencing pad 67 is disposed on the lower surface of the stopping piece 63 engaging with the operating portion 641 to prevent the key top 61 from contacting the stopping piece 63 when the key top 61 rebounds, and thereby the sound made at site C is eliminated. A second silencing pad 69 is disposed on the bottom surface of the side portion 66 that contacts the upper surface of the stopping piece 63 to eliminate the sound made at site B when the key top 61 is pressed down.

In the present invention, a method for manufacturing a keyboard is also disclosed. The structure of the keyboard is described in FIGS. 3 to 6. The method includes the step of forming the upper housing and the first silencing pad by an insert molding. In the insert molding, the upper housing and the first silencing pad are formed separately in two molds.

In the present invention, an alternative method for manufacturing a keyboard is also disclosed. The structure of the keyboard is described in FIGS. 3 to 6. The method includes the step of forming the upper housing and the first silencing pad by a double injection molding. In the double injection molding, the upper housing and the first silencing pad are formed in one mold. In the double injection molding, the first silencing pad located between the operating portion and the lower surface of the stopping piece is formed by changing the material on the uppermost 1 mm of the lower surface or the operating portion to silicon or thermoplastic polyurethane (TPU). Alternatively, the keyboard device further includes a second silencing pad. The second silencing pad located between the side portion and the upper surface of the stopping piece is formed by changing the material on the uppermost 1 mm of the upper surface or the bottom surface of the side portion to silicon or thermoplastic polyurethane (TPU).

Although the present invention has been described with reference to certain exemplary embodiments thereof, it would be understood by those skilled in the art that a variety of modifications and variations may be made to the present invention without departing from the spirit or scope of the present invention defined in the appended claims, and their equivalents.

### Embodiments

1. A keyboard device having an upper housing and an under housing, including a stopping piece integrally formed on the upper housing and having an upper surface and a lower surface, a key top having a side portion and an operating piece having an operating portion, a first silencing pad disposed between the operating portion and the lower surface, and a second silencing pad disposed between the side portion and the upper surface.

2. The keyboard device according to Embodiment 1 is a conventional keyboard or a thin keyboard, wherein the stopping piece is a top portion of a crater-like depression.

3. The keyboard device according to any one of Embodiments 1 and 2, wherein the keyboard device further includes an elastic body and a conductive membrane disposed on the under housing, wherein the conductive membrane has a three-layer structure including a first conductive layer, a protection layer and a second conductive layer.

4. The keyboard device according to any one of Embodiments 1 to 3, wherein the key top further comprises a column, and the column pushes the elastic body when the key top is pressed down.

5. The keyboard device according to any one of Embodiments 1 to 4, wherein each of the first silencing pad and the second silencing pad is one of a silicone pad and a thermoplastic polyurethane (TPU) pad having a thickness of 1 mm.

6. A keyboard device having an upper housing and an under housing, including a stopping piece integrally formed on the upper housing and having an upper surface and a lower surface, a key top having a side portion and an operating piece having an operating portion, and a first silencing pad disposed between the operating portion and the lower surface.

7. The keyboard device according to Embodiments 6 further includes a second silencing pad disposed between the side portion and the upper surface.

8. A method for manufacturing a keyboard, wherein the keyboard having an upper housing and an under housing, a stopping piece integrally formed on the upper housing and having an upper surface and a lower surface, a key top having a side portion and an operating piece having an operating portion, and a first silencing pad located between the operating portion and the lower surface, including the step of forming the upper housing and the first silencing pad by an insert molding.

9. The method according to Embodiment 8, wherein the keyboard device further includes a second silencing pad disposed between the side portion and the upper surface.

10. The method according to one of Embodiments 8 and 9, wherein the insert molding is performed in two molds.

11. The method according to any one of Embodiments 8 to 10, wherein the keyboard further includes an elastic body and a conductive membrane disposed on the under housing, wherein the conductive membrane has a three-layer structure including a first conductive layer, a protection layer and a second conductive layer.

12. The method according to any one of Embodiments 8 to 11, wherein the elastic body is a silicone rubber dome.

13. The method according to any one of Embodiments 8 to 12, wherein each of the first silencing pad and the second silencing pad is one of a silicone pad and a thermoplastic polyurethane (TPU) pad having a thickness of 1 mm.

14. A method for manufacturing a keyboard, wherein the keyboard having an upper housing and an under housing, a stopping piece integrally formed on the upper housing and having an upper surface and a lower surface, a key top having a side portion and an operating piece having an operating portion, and a first silencing pad located between the operating portion and the lower surface, the method including the step of forming the upper housing and the first silencing pad by a double injection molding.

15. The method according to Embodiment 14, wherein the keyboard device further comprises a second silencing pad disposed between the side portion and the upper surface.

16. The method according to one of Embodiments 14 and 15, wherein the double injection molding is performed in one mold.

17. The method according to any one of Embodiments 14 to 16, wherein the keyboard further includes an elastic body and a conductive membrane disposed on the under housing, wherein the conductive membrane has a three-layer structure including a first conductive layer, a protection layer and a second conductive layer.

18. The method according to any one of Embodiments 14 to 17, wherein the elastic body is a silicone rubber dome.

19. The method according to any one of Embodiments 14 to 18, wherein each of the first silencing pad and the second silencing pad is one of a silicone pad and a thermoplastic polyurethane (TPU) pad having a thickness of 1 mm.

What is claimed is:

1. A keyboard device having an upper housing and an under housing, comprising:
a stopping piece integrally formed on the upper housing and having an upper surface and a lower surface;
a key top having a side portion and an operating piece having an operating portion;
a first silencing pad disposed between the operating portion and the lower surface; and
a second silencing pad disposed between the side portion and the upper surface.

2. The keyboard device as claimed in claim 1 being a conventional keyboard or a thin keyboard, wherein the stopping piece is a top portion of a crater-like depression.

3. The keyboard device as claimed in claim 1, further comprising an elastic body and a conductive membrane disposed on the under housing, wherein the conductive membrane has a three-layer structure including a first conductive layer, a protection layer and a second conductive layer.

4. The keyboard device as claimed in claim 3, wherein the key top further comprises a column, and the column pushes the elastic body when the key top is pressed down.

5. The keyboard device as claimed in claim 1, wherein each of the first silencing pad and the second silencing pad is one of a silicone pad and a thermoplastic polyurethane (TPU) pad having a thickness of 1 mm.

6. A keyboard device having an upper housing and an under housing, comprising:
a stopping piece integrally formed on the upper housing and having an upper surface and a lower surface;
a key top having a side portion and an operating piece having an operating portion; and
a first silencing pad disposed between the operating portion and the lower surface.

7. The keyboard device as claimed in claim 6, further comprising a second silencing pad disposed between the side portion and the upper surface.

8. A method for manufacturing a keyboard, wherein the keyboard having an upper housing and an under housing, a stopping piece integrally formed on the upper housing and having an upper surface and a lower surface, a key top having a side portion and an operating piece having an operating portion, and a first silencing pad located between the operating portion and the lower surface, comprising the step of:
forming the upper housing and the first silencing pad by an insert molding.

9. The method as claimed in claim 8, wherein the keyboard device further comprises a second silencing pad disposed between the side portion and the upper surface.

10. The method as claimed in claim 8, wherein the insert molding is performed in two molds.

11. The method as claimed in claim 8, wherein the keyboard further comprises an elastic body and a conductive membrane disposed on the under housing, wherein the conductive membrane has a three-layer structure including a first conductive layer, a protection layer and a second conductive layer.

12. The method as claimed in claim 11, wherein the elastic body is a silicone rubber dome.

13. The method as claimed in claim 9, wherein each of the first silencing pad and the second silencing pad is one of a silicone pad and a thermoplastic polyurethane (TPU) pad having a thickness of lmm.

14. A method for manufacturing a keyboard, wherein the keyboard having an upper housing and an under housing, a stopping piece integrally formed on the upper housing and having an upper surface and a lower surface, a key top having a side portion and an operating piece having an operating portion, and a first silencing pad located between the operating portion and the lower surface, comprising the step of:
forming the upper housing and the first silencing pad by a double injection molding.

15. The method as claimed in claim 14, wherein the keyboard device further comprises a second silencing pad disposed between the side portion and the upper surface.

16. The method as claimed in claim 14, wherein the double injection molding is performed in one mold.

17. The method as claimed in claim 14, wherein the keyboard further comprises an elastic body and a conductive membrane disposed on the under housing, wherein the conductive membrane has a three-layer structure including a first conductive layer, a protection layer and a second conductive layer.

18. The method as claimed in claim 17, wherein the elastic body is a silicone rubber dome.

19. The method as claimed in claim 15, wherein each of the first silencing pad and the second silencing pad is one of a silicone pad and a thermoplastic polyurethane (TPU) pad having a thickness of 1 mm.
